(19) United States
(12) Patent Application Publication
(10) Pub. No.: US 2008/0222501 A1
(43) Pub. Date: Sep. 11, 2008

(54) Analyzing Test Case Failures

(75) Inventors: Daniel T. Travison, Carnation, WA (US); Jonathan A. White, Woodinville, WA (US); John A. Messec, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/682,708

(22) Filed: Mar. 6, 2007

(51) Int. Cl. G06F 7/02

(52) U.S. Cl. 714/819

(57) ABSTRACT

Apparatus and method for categorizing test failures are disclosed. In one embodiment, a data set of a current test failure is compared with the data sets of historical test failures to result in a set of correspondence values. The current test failure is categorized with respect to the historical test failures at least in part on the basis of the correspondence values.

### BACKGROUND

As software becomes more complex, correspondingly large sets of test cases need to be implemented. The test cases, for example validation codes, unit tests and so on, are run against a particular program to determine behavior of the program, stability during execution, and other types of program integrity. Commonly, these test cases are large in number even for smaller software development projects. A large number of test cases may result in a large number of test failures that need to be analyzed. A failure of a test case may be due to one or more known causes or may be due a new cause.

During the development of a program many test failures may be generated as a result of applying different test cases. A collection of test cases is known as a ‘test suite’. There may be situations in which many test suites are run each day, thereby increasing the number of test failures.

These failures can be analyzed manually. However, this is extremely time-consuming.

### SUMMARY

This summary is provided to introduce concepts relating to categorizing test failures, which are further described below in the detailed description. This summary is not intended to identify essential features of the claimed subject matter, nor is it intended for use in determining the scope of the claimed subject matter.

Apparatus and methods for categorizing test failures are disclosed. In one embodiment, data sets of a current test failure are compared with the respective data sets of known test failures to result in a set of correspondence values. The current test failure is categorized on the basis of the correspondence values.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates an exemplary architecture for categorizing test case failures.

FIG. 2 illustrates an exemplary central computing-based device.

FIGS. 3-7 illustrates an exemplary method(s) for categorizing a current failure as known or unknown.

### DETAILED DESCRIPTION

Techniques for categorizing test failures are described. These techniques are based on comparing data associated with newly-received or newly-occurring test failures against similar data associated with previously known and categorized test failures. For purposes of discussion, the term “current test failure” will be used to indicate a test failure that is the subject of analysis and categorization. The process described below involves receiving a current test failure (or data representing the failure), and comparing the current test failure to a library of historical or archived test failures. The archived test failures have already been analyzed and categorized.

The current test failure is compared to each historical test failure. Depending on the result of these comparisons, the current test failure is categorized either as being of a new type, or as being a repeated instance of a previously known type for which an example has already been analyzed and archived. The term “historical test failure under consideration” will be used at times in the subsequent discussion to indicate a particular historical test failure that is the current subject of comparison with respect to the current test failure. Also note that once analyzed and/or categorized, a current test failure potentially becomes a historical test failure, and the described process repeats with a new current test failure.

Test failures can be represented by data derived from the operational environment from which the test failures arise. Data associated with test failure includes information that relates to the state of the program being tested along with state information associated with computing resources, for example, memory, processing capability and so on. The system categorizes test failures as either known failures or new failures based on comparing the data associated with the current test failure against corresponding data associated with the known test failures.

While aspects of described systems and methods for categorizing test failures can be implemented in any number of different computing systems, environments, and/or configurations, embodiments of system analysis and management are described in the context of the following exemplary system architecture(s).

An Exemplary System

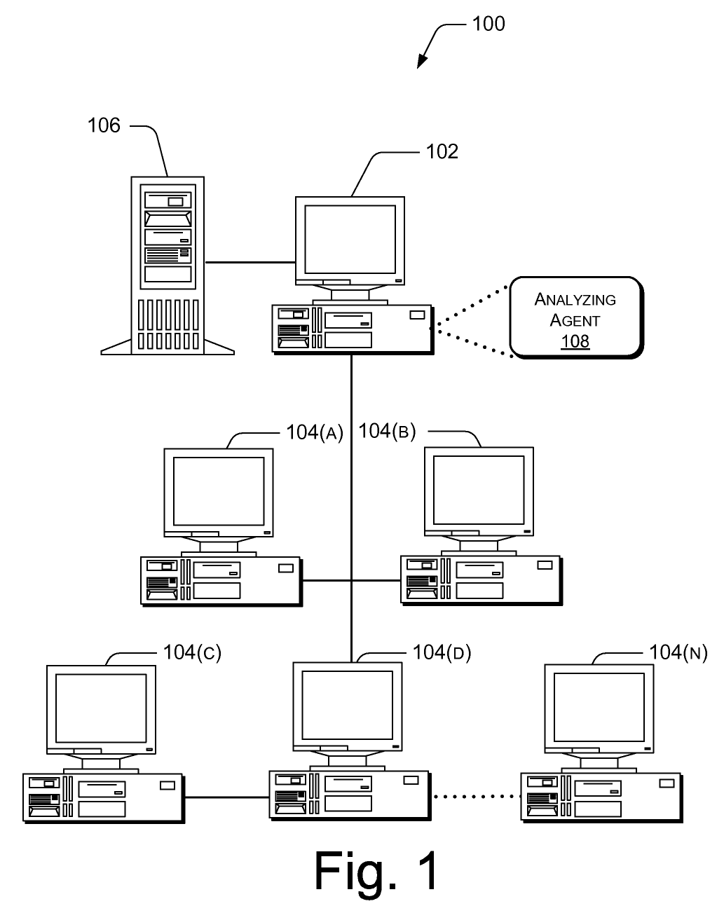

FIG. 1 illustrates an exemplary computer system 100 in which information associated with one or more test failures can be collected and the test failures categorized. Such categorization can include further analyses of test failures.

Information associated with a test failure can include data relating to the state of the failing program. The information associated with test failures can also indicate various state variables and how they are being handled. This failure data typically exists and is communicated as a data set, file, or package. It can also be referred to as a programming object in many computing environments. For the sake of brevity, the data will at times be referred to simply as “a failure” or “the failure,” which will be understood from the context to refer to the data, file, or object that contains or represents the failure data. At other times, this data will be referred to as a “data set.”

Computer system 100 includes a central computing-based device 102, other computing-based devices 104(a)-(n), and a collection server 106. Central computing-based device 102, computing-based devices 104(a)-(n), and collection server 106 can be personal computers (PCs), web servers, email servers, home entertainment devices, game consoles, set top boxes, and any other computing-based device.

Moreover, computer system 100 can include any number of computing-based devices 104(a)-(n). For example, in one implementation, computer system 100 can be a company network, including thousands of office PCs, various servers, and other computing-based devices spread throughout several countries. Alternately, in another possible implementation, system 100 can include a home network with a limited number of PCs belonging to a single family.

Computing-based devices 104(a)-(n) can be coupled to each other in various combinations through a wired and/or wireless network, including a LAN, WAN, or any other networking technology known in the art.

Central computing-based device 102 also includes an analyzing agent 108, capable of reporting and/or collecting data associated with the test failures and of comparing the data associated with a current test failure with the corresponding data associated with known test failures. Based on such comparisons, analyzing agent 108 can declare the current test failure as a known failure or as a new failure.

It will be understood, however, that analyzing agent 108 can be included on any combination of computing-based devices 102, 104(a)-(n). For example, in one implementation, one of the computing-based devices 104(a)-(n) in computing system 100 can include an analyzing agent 108. Alternately, in another possible implementation, several selected computing-based devices 102, 104(a)-(n) can include analyzing agent 108, or can perform parts of the work involved in categorizing failures.

Categorized test failures can be stored for future analysis or for use in categorizing subsequent test failures. For example, categorized test failures can be transmitted to another device, such as collection server 106, for retention, processing and/or further analysis. Collection server 106 can be coupled to one or more of computing-based devices 104(a)-(n). Moreover, one or more collection servers 106 may exist in system 100, with any combination of computing-based devices 102, 104 (a)-(n) being coupled to the one or more collection servers 106. In another implementation, computing-based devices 102, 104(a)-(n) may be coupled to one or more collection servers 106 through other computing-based devices 102, 104(a)-(n).

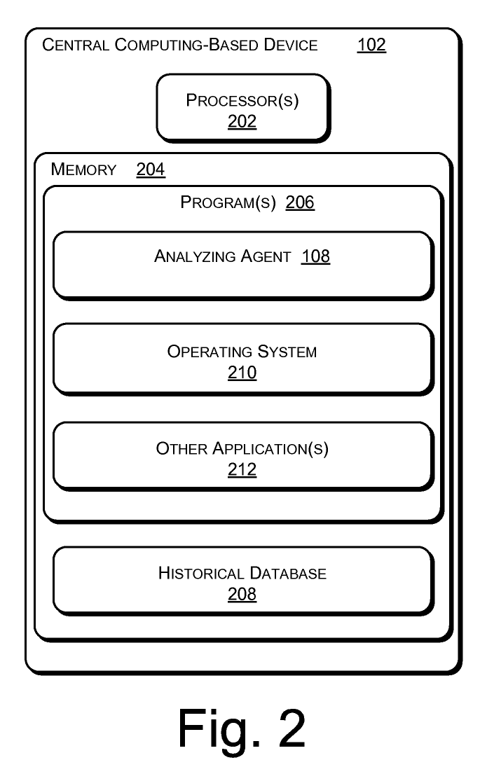

FIG. 2 illustrates relevant exemplary components of central computing-based device 102. Central computing-based device 102 includes one or more processor(s) 202 and memory 204. Processor(s) 202 might include, for example, microprocessors, microcomputers, microcontrollers, digital signal processors, central processing units, state machines, logic circuitries, and/or any devices that manipulate data and/or signals based on operational instructions. Among other capabilities, processor(s) 202 are configured to fetch and execute computer-readable instructions stored in memory 204.

Memory 204 can include any computer-readable medium known in the art including, for example, volatile memory (e.g., RAM) and/or non-volatile memory (e.g., flash, etc.), removable memory, etc. As illustrated in FIG. 2, memory 204 also can include program(s) 206 and historical database 208. Generally, the programs are embodied as instructions on one or more computer-readable media. Program(s) 206 include, for example, analyzing agent 108, an operating system 210, and other application(s) 212. Other application(s) 212 include programs that supplement applications on any computing based device such as word processor applications, spreadsheet applications, and such.

As discussed above analyzing agent 108 collects data associated with newly-occurring test failures, each of which is referred to herein as the current test failure during the time it is being categorized. In particular, each failure (whether new or historical) is represented as a set of failure data. In the described embodiment, the failure data includes logical attributes that are each formatted as a name and a corresponding value. Based on the failure data, agent 108 categorizes each newly encountered current test failure as either a new instance of a previously known failure type, or an instance of new type of failure that has not been previously investigated. In some cases, this categorization is performed in conjunction with human interaction and judgment.

Once analyzed, the failure data associated with each test failure is stored in historical database 208, along with appended information indicating things such as the type of failure and possible annotations made by an analyst.

As mentioned, the failure data itself can include many different types of information or attributes, reflecting output from an in-test program as well as more general state information regarding the program and other aspects of the computer on which it is executing. For example, the attributes may identify the particular test case that produced the failure; inputs and outputs that occurred in conjunction with the test case or failure; the state of the call stack at the time of the failure; characteristics of the runtime environment such as processor type, processor count, operating system, language, etc.; characteristics of the build environment that produced the code being tested, such as debug vs. release build, target language, etc. One way to obtain test failure data is to monitor attributes in text logs created by in-test programs or by other programs or operating system components.

The objective of analyzing agent 108 is to categorize each newly occurring failure; or failing that, to flag uncategorized failures for further investigation by an analyst.

In order to perform this categorization, analyzing agent 108 compares the attributes of the current failure with the corresponding attributes of previously encountered failures stored in historical database 208. In the simplest case, if the attribute values of the current failure match those of a previously categorized failure, the new failure can be assumed to be another instance of that previously categorized failure.

The comparison can be a simple true/false comparison between corresponding attributes, or can be refined in a number of ways to increase accuracy. Several techniques for refining results will be described below.

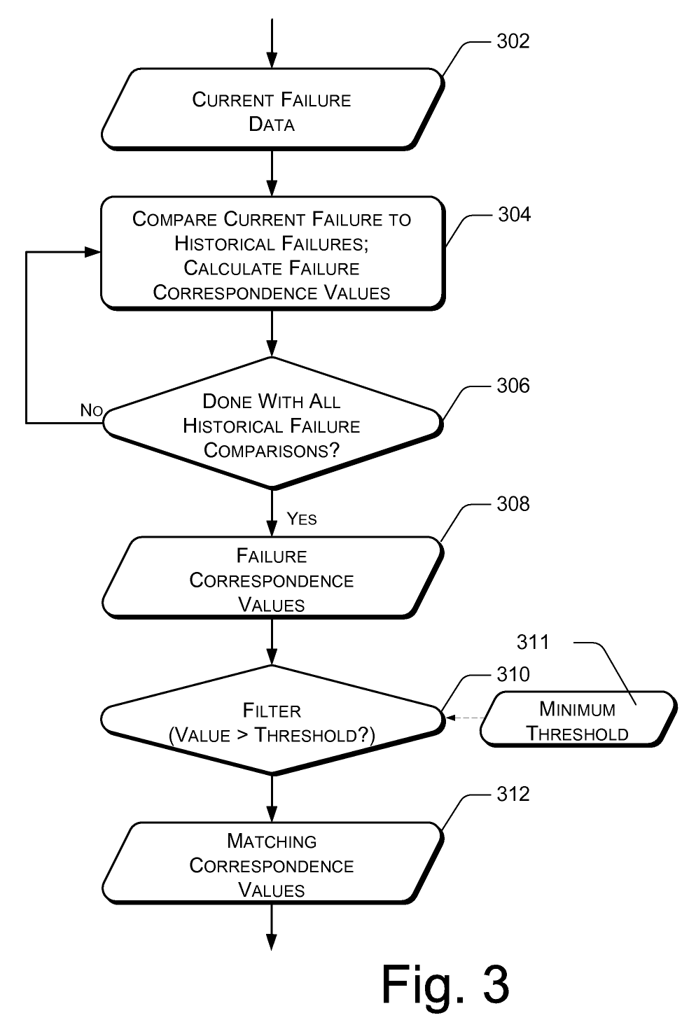

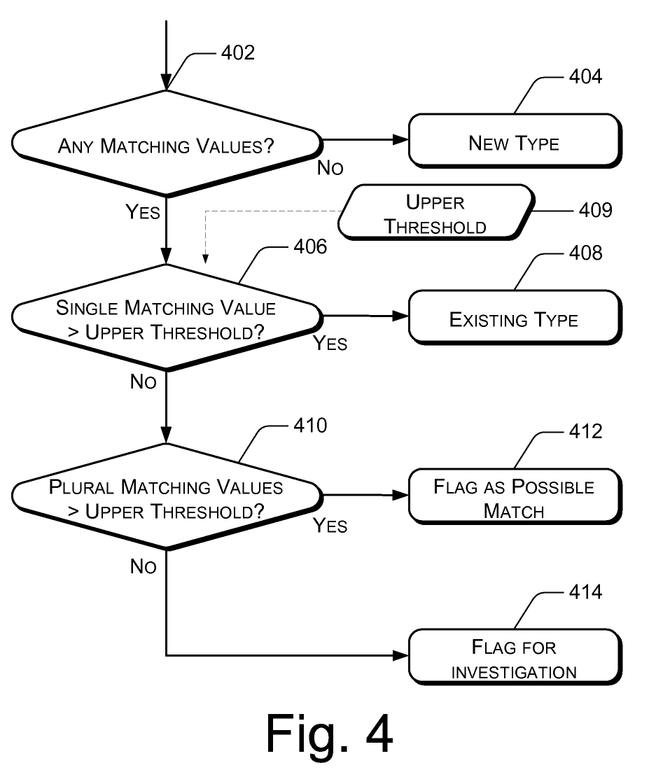

FIGS. 3 and 4 illustrate one implementation in general terms. In FIG. 3, a data set 302 representing a current failure to be analyzed is compared in an action 304 against the data sets of historical failures. More specifically, block 304 along with decision block 306 form an iterative loop that performs attribute comparisons between the current failure data and the historical or archived failure data: action 304 is repeated for each of the available or relevant historical failures. At each iteration, analyzer 108 calculates a failure correspondence value. The result is a set of failure correspondence values 308, indicating the degree of similarity or correspondence between the current failure and each of the archived historical failures. Thus, values 308 typically include a failure correspondence value corresponding to each of the relevant historical failures.

Failure correspondence values 308 can be simple true/false values, each indicating either a matching historical failure or a non-matching historical failure. Alternatively, failure correspondence values 308 can be numbers or percentages that represent increasing degrees of matching between the current failure and the historical failures. In the following discussion, it will be assumed that the failure correspondence values are percentages, represented by integers ranging from 0 to 100.

An action 310 comprises filtering the failure correspondence values, retaining only those that meet or exceed some previously specified minimum threshold 311. This results in a set of potentially matching correspondence values 312, corresponding to historical failures that might match the current failure.

FIG. 4 shows further processing to determine how a current failure might be categorized with respect to historical failures. An action 402 comprises determining whether the process of FIG. 3 found any potentially matching correspondence values. If the answer is “no”, the current failure is categorized in block 404 as a failure of a new type, with no correspondence to previously recorded failures. It is flagged for investigation by a programmer or developer, and stored as a historical failure.

If the answer to decision 402 is “yes”, an action 406 is performed, comprising determining whether a single “best” match can be determined from the potentially matching correspondence values 312. If so, the current failure is categorized in an action 408 as an instance of the same failure type as that of the failure having the best matching correspondence value. Since this is a known and previously analyzed failure, it may not be necessary to store the failure data of the current test failure in historical database 208. In many cases, however, it may be desirable for an analyst to view even categorized failures such as this in order to further characterize failures or to improve future categorization efforts. Thus, the current failure, which has been categorized as a known failure, can also be stored in collection server 106 for future analyses.

Decision 406 can be performed in various ways. In the described embodiment, it is performed by comparing the potentially matching correspondence values 312 to a previously specified upper threshold 409. If only a single matching correspondence value 310 exceeds this threshold, that value is judged to be the “best” match, resulting in a “yes” from decision 406. In any other case, the result of decision 402 is “no”; such as if none of values 312 exceed the upper threshold or more than one of values 312 exceed the threshold.

If the result of decision 406 is “no”, an action 410 is performed, comprising determining whether multiple potentially matching correspondence values 310 exceed the previously mentioned upper threshold 409. If so, action 412 is performed, comprising flagging the current failure as a potential match with the previously categorized failures corresponding to the multiple potentially matching correspondence values. This indicates that the current failure needs further investigation to determine which of the identified possibilities might be correct. References to those historical failures with failure correspondence values exceeding the upper threshold are added to the data set of the current failure as annotations. A programmer subsequently analyzes the actual failure and manually categorizes it as either a new type of failure or an instance of a previously known failure-likely one of the multiple historical failures identified in decision 410. In either case, the current failure is then stored in historical database 208 as a historical failure, to be used in future comparisons. Alternatively, repeated instances of known failures may be recorded separately.

If the result of decision 410 is “no”, indicating that one or fewer of the potentially matching correspondence values exceeded the upper threshold, an action 414 is performed, comprising flagging the current failure as needing further investigation. An analyst will investigate this failure and manually categorize it as either a new type of failure or an instance of a previously known type of failure. The corresponding data set will be archived in historical database 208.

FIGS. 3 and 4 illustrate but one example of how failure correspondence values might be calculated to determine how to classify or categorize reported failures. Variations and alternatives are anticipated, depending on the precise needs at hand.

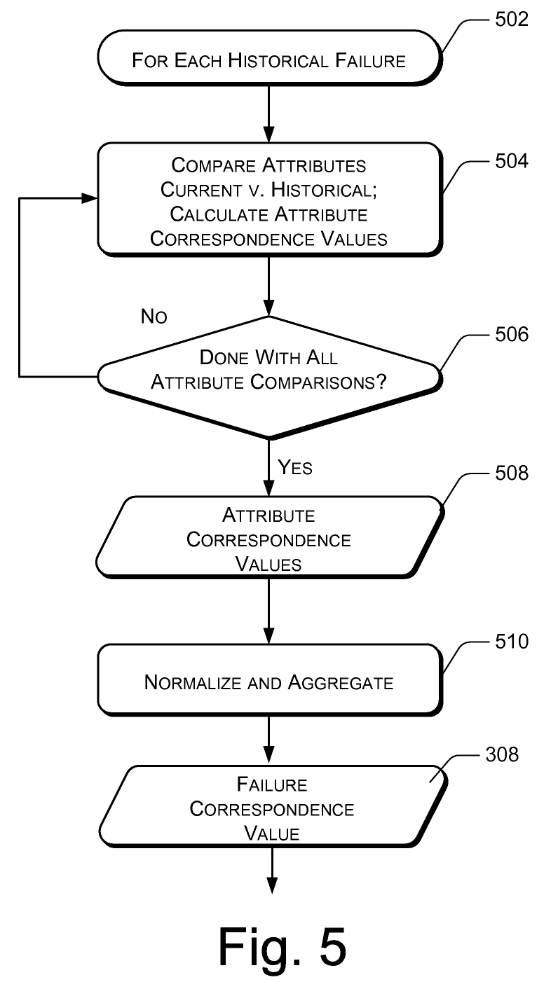

FIG. 5 illustrates steps involved in comparison 304 to determine a failure correspondence value corresponding to a particular historical failure, with respect to a current failure. The steps of FIG. 5 are repeated for all or a subset of the archived and relevant historical failures to produce failure correspondence values corresponding to each such historical test failure. Block 502 indicates that the illustrated steps are performed for every historical test failure.

An action 504 comprises comparing an attribute of the current failure to the corresponding attribute of the historical failure. In the simplest case, this might involve simply testing for an exact match, resulting in either a true or false result. This might be appropriate, for example, when comparing an attribute representing processor type. In more complex situations, this comparison might involve rules and functions for comparing the attributes of each failure. Rules might include range checking, ordered, union, and subset tests. Another example might be a rule that requires an exact match.

In some cases, actual analysis of a test failure by an analyst will reveal that not all of the attributes associated with the failure are actually contributory or relevant to the particular test failure being recorded. As will be explained below, rules or attribute comparison criteria can be specified for individual historical failures to mask or de-emphasize such attributes for purposes of future comparisons. As an example, certain entries of a call stack might desirably be masked so as to leave only entries that are actually relevant to a particular historical test failure.

Rules can also be much more complex. Attribute comparison rules can be specified as either global or local. Global rules apply in all failure comparisons, while local rules correspond to specific historical test failures. When performing a comparison against a particular historical failure, all global rules are observed, as are any local rules associated with that particular historical failure. Local rules take precedence over global rules, and can therefore override global rules.

Global rules are typically specified by an analyst based on general knowledge of a test environment. Local rules are typically specified during or as a result of a specific failure analysis. Thus, once an analyst has analyzed a failure and understood its characteristics, the analyst can specify local rules so that subsequent comparisons to that historical failure will indicate a potential match only when certain comparison criteria are satisfied or as the result of performing the comparison in a customized or prescribed manner.

The result of each attribute comparison is expressed as an attribute correspondence value. As indicated by block 506, comparison 504 is repeated for each attribute of the relevant data set. This results in a collection of attribute correspondence values 508.

In this example, attribute correspondence values 508 are expressed as percentages in the range of zero to 100, where zero indicates a complete mismatch, 100 indicates a complete match, and intermediate values indicate the percentage of that value that matches. These values can be influenced or conditioned by rules.

A subsequent action 510 comprises normalizing and aggregating the attribute correspondence values 508 to produce a single failure correspondence value indicating the degree of correspondence between the current test failure and the historical test failure. This might involve summing, averaging, or some other function.

Aggregation 510 generally includes weighting the various attribute correspondence values 508 so that certain attributes have a higher impact on the final failure correspondence value. As an example, attributes relating to runtime data such as parameter values or symbol names typically have a greater impact on failure resolution than an attribute indicating the operating system version of the computer on which the test is executed. To support this concept, the comparison process factors in the weight of the attribute when computing the final failure correspondence value.

A weighting algorithm can be implemented by associating a multiplier with each failure attribute. An attribute with a multiplier of four would have four times more impact on the comparison than an attribute with a multiplier of one.

Attribute weights and other mechanisms for influencing attribute comparisons can be assigned and applied either globally or locally, in global or local rules. As an example of how local weighting factors might be used, consider a failure that occurs only on systems configured for a German locale. A local weighting factor allows the analyst to place a high emphasis on this attribute. This concept provides a mechanism for allowing attributes that are significant to the failure to have a greater impact on the comparison. Unlike global weighting, failure specific or local weighting is defined for a given historical failure, often based on investigation of the failure by test or development.

In addition to the weighting techniques described above, or as an alternative to those techniques, it might be desirable to establish global or local rules that flag selected individual attributes as being “significant.” During the comparison with a particular historical failure, significant attributes would get special treatment.

As an example, the system might be configured to declare a match between failures if those attributes that both match and are “significant” account for at least a pre-specified minimum percentage of the final correspondence value. In other words, a current failure is considered to match a historical failure if all attributes of the previous failure marked as significant completely match those of the current failure and the total weight of these significant attributes accounts for a predefined percentage of the total correspondence value, such as 75%.

As another example, the system might be configured to globally define a multiplier for an attribute when that attribute is marked as significant. For example, the language attribute might have a default multiplier of one unless the attribute is marked as significant in a particular historical failure; in which case a multiplier of three would be used.

By default, a single value comparison contributes to the normalized failure correspondence values based on its relative weight; this is referred to as a relative constraint. However, the process can also include the concept of an absolute constraint. An absolute constraint indicates the significant portions of an attribute value that must match between the current test failure and a historical test failure. If this portion of the corresponding values does not match, the historical failure is rejected as a possible match with the current failure, regardless of any other matching attribute values.

As an example, for a failure that occurs only on a specific processor type, only those current failures with that same processor type should be categorized as matching. Thus, the processor type is designated in this example as an absolute constraint.

Note that for complex values, such as call stacks, the significant portions of the value must completely match when specified as an absolute constraint. However, portions of the call stack marked as ignored do not impact the comparison.

Also note that the absolute comparison supports the logical NOT operation. This indicates that some or all of the significant portions of the value must not match. For example, a failure that only occurs on non-English builds would be annotated to require the build language to not equal English.

As demonstrated, there are a variety of ways the attributes can be compared and evaluated to produce correspondence values between a current failure and a plurality of historical failures.

As a further refinement, context specific comparisons might be specified for individual historical test failures. Using the techniques described thus far, attributes are compared in isolation and the result of each comparison is weighted and normalized to produce a final result. However, this process may still result in multiple matches or even false matches. To further refine the comparison process, the described system can be designed to accept rules that allow each attribute comparison to reference one or more other, related attributes of the current test failure. Additionally, context-specific attribute comparison rules might specify some criteria or function based only on one or more attributes of the current test failure, without reference to those attributes of the historical test failure under consideration. These types of rules are primarily local rules, and are thus specified on a per-failure basis by an analyst after understanding the mechanisms of the failure.

Context-specific rules such as this allow the analyst to set arbitrary conditions that are potentially more general than a direct comparison between the attributes of the current and historical test failures. For example, a function that writes a file to disk might fail if there is insufficient memory to allocate the file buffers. In this situation, the analyst may want to require, as a prerequisite to a match, that the current test failure have attributes indicating that the file buffer size is greater than the remaining free memory. This is strictly a relationship between different attributes of the current test failure, rather than a comparison of attributes between the current test failure and the historical test failure. A rule such as this allows the analyst to specify relationships between attributes of the current test failure.

The result of a single context-specific rule is treated similarly to the result of a direct attribute comparison. It is optionally assigned a weighting factor and a significance value, and scaled or normalized to a percentage between 0 and 100. Thus, a particular context-specific rule will normally be only a single qualification or factor out of many in determining a match with a previous failure; other attributes would normally have to match in order to produce a high failure correspondence value. However, given appropriate weighting, a context-specific rule may supersede all other attribute comparisons.

Context-specific rules can be either global or local. However, as the list of known failures increases, globally defined context-specific rules may have an unacceptable impact on processing time since these rules are executed O(n) times. Accordingly, it is suggested that these types of rules be local rather than global.

The actual comparison of attributes values, illustrated by step 504 of FIG. 5, can be customized depending on the data types of the attribute values. In comparing the attribute values of two failures, many different data types will potentially be involved. An analyst can specify different algorithms for each different type of data. Thus, the failure analysis process is enhanced and refined by adding insights of an analyst or investigator.

For example, the algorithm for comparing processor types is unrelated and quite different than the algorithm for comparing call stacks. While both comparisons return a value of 0 to 100, each comparison algorithm is type specific. This allows analysts to add new types of failure data to the system without changing the overall design of the system. In fact, the design can be made to explicitly provide the ability for analysts to add additional types of data to the system.

The different data types may also support additional annotation capabilities and the method for applying the annotations to the data value may be specific to the data type.

For example, the processor type has the concept of processor groups. A processor group is a union of all processor types that fit a given characteristic, such as 32 bit versus 64 bit processor types. This allows the investigator to annotate the value to indicate the failure occurs on any 64 bit processor (ia64 or x64) or that it is specific to a given processor (ia64).

In contrast, the call stack type has a completely different comparison and annotation model allowing the investigator to indicate individual stack frames that are significant or ignored.

In the described comparison process, failure comparisons are distinguished from attribute comparisons. Failure comparisons are performed as indicated in FIGS. 3 and 4, and are performed in the same manner against each historical failure. In contrast, the attribute comparisons of FIG. 5 are specific to the type of data being compared, and are thus potentially different for each different data type. Distinguishing failure comparison from value comparison allows the system to be extended to include other types of failure data such as trace output, the list of running processes, or network packets. Additionally, it allows the system to be adapted to other ‘failure analysis’ scenarios such as Watson bucket analysis.

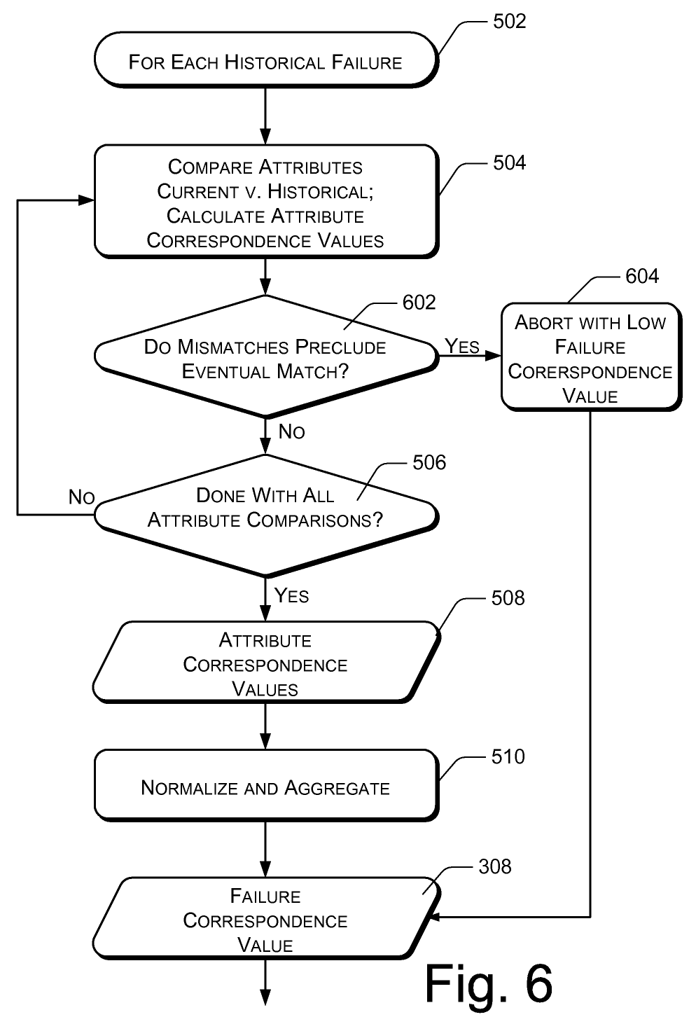

FIG. 6 shows the process of FIG. 5 with an additional optimization. In this alternative, the loop comprising blocks 504 and 506 is potentially interrupted by a decision 602 regarding whether enough attribute mismatches have been detected to preclude the possibility of the failure correspondence value reaching or exceeding the minimum threshold of step 310 (FIG. 3). This allows the loop to be aborted in block 604 prior to completing all possible attribute comparisons: since remaining comparisons do not have enough weight to raise the failure correspondence value to the minimum threshold, there is no need to continue with the comparisons.

This optimization can be improved by moving specific attributes to the start of the attribute list to ensure they are compared first. These values are those that are mismatched most often and are inexpensive to compare. Examples included values such as processor type, process type, language, build and OS version. Moving these to the start of the list increases the opportunity for an “early abort” with minimal comparison overhead.

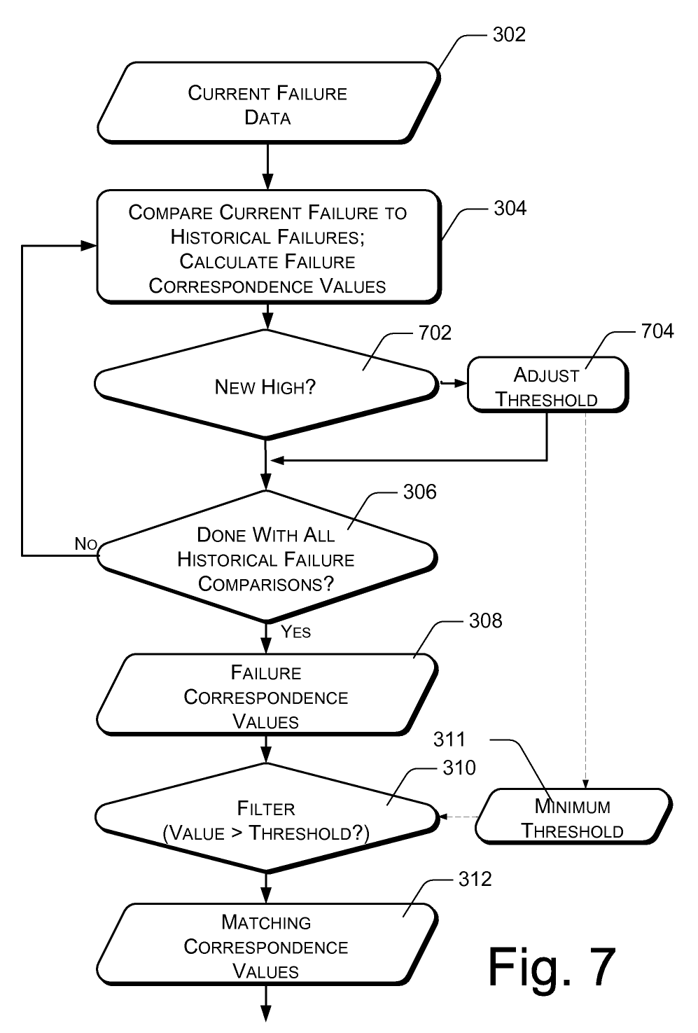

FIG. 7 shows the process of FIG. 3 with another optimization. In this alternative, the minimum threshold 311 is varied depending on various factors. For example, in the example of FIG. 7, a decision 702 is made regarding whether the current failure correspondence value is the highest value yet encountered. If it is, a step 704 involves adjusting minimum threshold 311 to maintain a desired or pre-defined delta between the highest-occurring failure correspondence value and minimum threshold value 311. For example, if the desired delta is 25% and a match is found with a result of 90%, minimum threshold value 311 is increased to 65%. Thus, the matching correspondence values 312 will include only those that exceed 65%.

Alternatively, similar results can be accomplished by setting a limit on the number of matching correspondence values that will be allowed to pass through filter 310. As an example, filter 310 might be configured to allow only the highest twenty values to pass through and become part of matching correspondence values 312.

Combining the refinements of FIGS. 6 and 7 can further improve categorization results.

### CONCLUSION

Although embodiments for analyzing test case failures have been described in language specific to structural features and/or methods, it is to be understood that the subject of the appended claims is not necessarily limited to the specific features or methods described. Rather, the specific features and methods are disclosed as exemplary implementations for analyzing test case failures.

1. A method for categorizing test failures based on data sets corresponding respectively to the test failures, the method comprising:
comparing the data set of a current test failure with data sets of historical test failures to produce failure correspondence values; and
categorizing the current test failure depending at least in part on the failure correspondence values.

2. The method of claim 1, wherein the data sets indicate attribute values, the comparing comprising:
comparing respective attribute values of the data set of the current test failure with corresponding attribute values of the data set of the historical test failures.

3. The method of claim 1, wherein the data sets indicate attribute values having different data types, further comprising:
accepting annotations to the attribute values, such annotations being different depending on the data types of the attribute values.

4. The method of claim 1, wherein the data sets indicate attribute values having different data types, the comparing comprising:
comparing respective attribute values of the data set of the current test failure with corresponding attribute values of the data set of the historical test failures, using comparison algorithms that are different for the different data types.

5. The method of claim 1, wherein the categorizing includes declaring the current test failure to be an instance of a historical test failure if at least one of the correspondence values is greater than a threshold value.

6. The method of claim 1, wherein the categorizing includes identifying multiple historical test failures that exceed a threshold value.

7. The method of claim 1, wherein the categorizing includes declaring the current test failure to be a new test failure if none of the correspondence values is greater than a threshold value.

8. The method of claim 1, further comprising:
associating different attribute comparison criteria with the respective historical test failures, said attribute comparison criteria being specified by an analyst after investigation of the historical test failures.

9. One or more computer-readable media containing instructions for analyzing current test failures, the instructions being executable by a computer to perform actions comprising:
comparing data sets of a current test failure with corresponding data sets of one or more known test failures;
generating failure correspondence values based on said comparing;
determining whether the current failure is an instance of one of the known failures based at least in part on the correspondence values.

10. The computer-readable media of claim 9, wherein the determining includes declaring the current test failure as an instance of a known test failure if at least one of the correspondence values is greater than a threshold value.

11. The computer-readable media of claim 9, wherein the determining includes declaring the current test failure to be a new test failure if none of the correspondence values is greater than a threshold value.

12. The computer-readable media of claim 9, wherein the data sets indicate attribute values, the comparing comprising:
comparing respective attribute values of the data set of the current test failure with corresponding attribute values of the data set of the known test failures.

13. The computer-readable media of claim 9, wherein the data sets indicate attribute values having different data types, the comparing comprising:
comparing respective attribute values of the data set of the current test failure with corresponding attribute values of the data set of the known test failures, using comparison algorithms that are different for the different data types.

14. One or more computer-readable media containing instructions for categorizing test failures based on data sets corresponding respectively to the test failures, wherein the data sets indicate attribute values, the instructions being executable by a computer to perform actions comprising:
comparing respective attribute values of the data set of a current test failure with corresponding attribute values of data sets of historical test failures to produce failure correspondence values; and
categorizing the current test failure depending at least in part on the failure correspondence values.

15. One or more computer-readable as recited in claim 14, wherein the attribute values have different data types, the actions further comprising:
accepting annotations to the attribute values, such annotations being different depending on the data types of the attribute values.

16. One or more computer-readable as recited in claim 14, wherein the attribute values have different data types, the actions further comprising:
comparing respective attribute values of the data set of the current test failure with corresponding attribute values of the data set of the historical test failures, using comparison algorithms that are different for the different data types.

17. One or more computer-readable as recited in claim 14, wherein the categorizing includes declaring the current test failure to be an instance of a historical test failure if at least one of the correspondence values is greater than a threshold value.

18. One or more computer-readable as recited in claim 14, wherein the categorizing includes identifying multiple historical test failures that exceed a threshold value.

19. One or more computer-readable as recited in claim 14, wherein the categorizing includes declaring the current test failure to be a new test failure if none of the correspondence values is greater than a threshold value.

20. One or more computer-readable as recited in claim 14, associating different attribute comparison criteria with the respective historical test failures, said attribute comparison criteria being specified by an analyst after investigation of the historical test failures.
